(19) United States
(12) Patent Application Publication
(10) Pub. No.: US 2015/0266342 A1
(43) Pub. Date: Sep. 24, 2015

(54) CASTOR DIRECTION CONTROL

(71) Applicant: FALLSHAW HOLDINGS PTY LTD, Sunshine, Victoria (AU)

(72) Inventors: Stephen Edward Howard, Box Hill North (AU); Mathew Keith Trainor, West Melbourne (AU)

(21) Appl. No.: 14/437,146

(22) PCT Filed: Oct. 18, 2013
(86) PCT No.: PCT/AU2013/001207

§ 371 Date: Apr. 20, 2015

(30) Foreign Application Priority Data
Oct. 19, 2012 (AU) 2012904597

(51) Int. Cl. B60B 33/02; G05D 1/02; B60B 33/00

(52) U.S. Cl. CPC B60B 33/028; B60B 33/0002; B60B 33/0068; G05D 1/021

(57) ABSTRACT

A castor control unit for a swivel castor has a plurality of selectable modes of operation. The modes of operation include at least a free mode, in which the castor (14) can freely swivel about a swivel axis (26) and a wheel or wheels (30,32) of the castor can rotate about a rolling axis (28), and a direction lock mode, in which the castor is locked against swivelling about the swivel axis and the wheel or wheels of the castor can rotate about the rolling axis. The castor control unit (70) comprises a measuring means (154) for measuring motion, a processing means (150) that deduces, from the measured motion, whether there is a need to engage or disengage the direction lock mode, and an actuating means (120a) for actuating the castor to engage or disengage the direction-lock mode of operation. The actuating means is controllable by a control signal, and the control signal is determined, at least in part, from the deduction of whether there is a need to engage or disengage the direction lock mode. Also disclosed are a processing module, a control system and a method of controlling a castor.

### FIELD OF THE INVENTION

The invention relates to swivel castors. Such castors are employed as wheel assemblies for ground or floor mobile items in a wide variety of applications, including trolleys, hospital beds and a range of mobile industrial and commercial equipment.

### BACKGROUND TO THE INVENTION

Many ground or floor mobile items use swivel castors to enable the item to be rolled. Typically, such items are mounted on four swivel castors, divided in to pairs of castors at or near opposing ends of the item. For a castor-mounted item that is generally rectangular, in plan view, a castor will generally be located beneath each corner of the item.

When the swivel castors beneath the item are free to swivel about a vertical axis, the castors will swivel to align themselves in the direction of travel. The castors' ability to swivel enables the orientation of the castor-mounted item to change its motion in any direction from its present position, which can be particularly useful in a confined space. However, the castors' continuous alignment with the direction of motion makes it difficult to steer the item.

Some recently developed castors include a direction-lock that may be engaged to lock the castor in a desired or preselected direction from which the castor cannot swivel. Engagement of the direction lock enables improved steering of the item. By engaging a direction-lock to the castors at one end of the castor-mounted item, a pivot axis is created at that end of the item, which allows the item's direction of travel to be controlled by pivoting the item about the pivot axis.

The present invention addresses a need for improved control over motion of a castor-mounted item.

It is not admitted that any background information presented or referred to in this' specification forms part of the common general knowledge in Australia or any other jurisdiction.

### SUMMARY OF THE INVENTION

In a first aspect of the present invention there is provided a castor control unit for a swivel castor having a plurality of selectable modes of operation, the modes of operation including at least: (i) a free mode, in which the castor can freely swivel about a swivel axis and a wheel or wheels of the castor can rotate about a rolling axis; (ii) a direction lock mode, in which the castor is locked against swivelling about the swivel axis and the wheel or wheels can rotate about a rolling axis, wherein the castor control unit comprises:
a measuring means for measuring motion;
a processing means that deduces, from the measured motion, whether there is a need to engage or disengage the direction lock mode; and
an actuating means for actuating the castor to engage or disengage the direction-lock mode of operation, the actuating means being controllable by a control signal,
wherein the control signal is determined, at least in part, from said deduction of whether there is a need to engage or disengage the direction lock mode.

In one embodiment, the processing means specifically determines whether there is a need to engage the direction lock mode. In another embodiment, the processing means specifically determines whether there is a need to disengage the direction lock mode.

The processing means is preferably a processing module in accordance with the second aspect of the present invention described hereinafter.

In one embodiment, the measuring means is an accelerometer.

Preferably, the actuating means includes an electromechanical device for actuating an activator on a swivel castor, the activator having a plurality of selectable positions that engage the respective selectable modes of operation of the swivel castor.

In one embodiment, the electromechanical device is a servo or stepper motor, although any other suitable driver could of course be employed.

Preferably, the castor control unit includes a means for determining the mode of operation in which the swivel castor is operating. In one embodiment the means for determining the mode of operation is at least one, preferably two, and more preferably three, mechanically actuated electronic switches.

Preferably, the castor control unit includes a housing for attaching the castor control unit to, or integrating the castor control unit in, the swivel castor.

Preferably, the castor is configured such that the direction lock mode locks the castor against swivelling from a predefined direction of orientation.

In a second aspect, the present invention provides a processing module for a castor-mounted item having a plurality of swivel castors on, which the item may stand, wherein the castors are rotatable to swivel about a generally upright axis with respect to the item when the item stands on the castors, wherein the item includes a direction-lock that is selectable to lock one or more of the castors against said swivel rotation while permitting a wheel or wheels of the castor to rotate about a rolling axis, the processing module including a processing system configured to:
receive a measurement signal measuring motion of the item or of at least one of the castors; and
in the event that the measured motion satisfies at least one predefined condition: (i) characterise a need to engage or disengage the direction lock based on the measured motion and (ii) generate at least one output signal indicating said characterisation.

In one embodiment, the predefined condition is that the item or the at least one castor has motion in a constant direction for a prescribed period, and the characterisation includes a need to engage the direction lock.

Preferably, the characterisation identifies: (a) which of engagement or disengagement is needed; and (b) a subset of the castors for which the engagement or disengagement needs to be applied.

Preferably, when there is a need for engagement of the direction lock, the identified subset of castors includes at least one castor that is leading other castors on the item. Preferably, the identified subset is, in this case, two adjacent castor wheels.

Preferably, the item has a first set of castors and a second set of castors at, or near, opposite ends of the item.

Preferably the characterisation is based on a quantitative, or scalar, measurement of the motion and a directional measurement of the motion that are measured by the measurement signal.

In one embodiment, the at least one output signal is a control signal for selectively controlling engagement or disengagement of the direction lock in accordance with the characterised need.

The processing module may further include a memory system for storing computer program processing instructions, the memory system being readable by the processing system to execute said instructions, wherein execution of the instructions by the processing system results in said configuration of the processing system.

It is a third aspect of the present invention to provide a control system for a castor-mounted item having a plurality of swivel castors on which the item may stand, wherein the castors are rotatable to swivel about a generally upright axis with respect to the item when the item stands on the castors, wherein the item includes a direction-lock that is selectable to lock one or more of the castors against said rotation while permitting a wheel or wheels of the castor to rotate about a rolling axis, wherein the control system includes a processing system configured to:
select a mode of operation based on (i) a characterisation of a need to engage or disengage the direction lock and (ii) additional factors; and
output at least one control signal in accordance with the selected mode to selectively control engagement or disengagement of the direction lock,
wherein the characterisation is derived based on motion data, the motion data encoding a measurement of motion of the item or of at least one of the castor wheels.

In an embodiment, the control system includes an input for receiving at least one input signal that indicates the characterisation. The processing system may, in this case, further include an accelerometer from which the motion data is generated.

In another embodiment, the control system is further configured such that in the event that the motion data satisfies at least one predefined condition, the processing system characterises the need for engagement or disengagement of the direction lock.

The control system may further include a memory system for storing computer program processing instructions, the memory system being readable by the processing system to execute said instructions, wherein execution of the instructions by the processing system results said configuration of the processing system.

It is a fourth aspect of the present invention to provide a swivel castor having a direction-lock mode and a free mode; and including an activator for selectively engaging and disengaging the direction-lock mode and a castor control unit in accordance with the first aspect of the present invention, wherein the actuating means of the castor control unit actuates the activator to selectively engage or disengage the direction-lock mode of operation.

In another aspect of the present invention, there is provided a ground or floor mobile item having a body and a plurality of, preferably four, swivel castors, on which the body is mounted, at least one of the swivel castors being a swivel castor in accordance with the fourth aspect of the present invention.

Preferably, each of the other swivel castors on which the ground or floor mobile item is mounted comprise at least:
a means for mounting the swivel castor to an item;
at least one wheel attached to the mounting means such that it has (i) a horizontal rolling axis for rolling along a ground surface when the item is mounted on the castor, and (ii) a vertical swivel axis about which the swivel castor may swivel;
a plurality of selectable modes of operation, the modes of operation including at least: (i) a free mode, in which the castor can freely swivel about a swivel axis; (ii) a direction lock mode, in which the castor is locked against swivelling about the swivel axis;

an electronically controllable activator having a plurality of selectable positions that engage the respective selectable modes of operation of the swivel castor.

Preferably, the ground or floor mobile item further includes a control system in accordance with the third aspect of the present invention. Preferably the control system is configured such that the least one control signal is comprised of a plurality of control signals for controlling each of the activators of the respective swivel castors on which the item is mounted.

It is another aspect of the present invention to provide a method for controlling a castor on a ground or floor mobile item, which castor has a direction lock mode of operation, the method including:
receiving a measurement signal measuring motion of the item or of at least one of the castors;
processing the measurement signal to deduce whether there is a need to engage or disengage the direction lock mode; and
generating at least one output signal based, at least in part, on said deduction of whether there is a need to engage or disengage the direction lock mode.

As used herein, except where the context requires otherwise, the term “comprise” and variations of the term, such as “comprising”, “comprises” and “comprised”, are not intended to exclude further'additives, components, integers or steps.

### BRIEF DESCRIPTION OF THE DRAWINGS

Further aspects of the present invention and further embodiments of the aspects described in the preceding paragraphs will become apparent from the following description, given by way of example and with reference to the accompanying drawings.

FIG. 1 is a highly schematic plan view of a castor-mounted ground or floor mobile item 10, such as a trolley .or bed, illustrating embodiments of various aspects of the invention;

FIG. 2 is a front perspective view of a swivel castor having an electro-mechanical activator;

FIG. 3 is a rear perspective view of a swivel castor similar to FIG. 2, but having a processing module in accordance with an embodiment of the present invention;

FIG. 4 is an enlarged partly-cutaway view of the processing module of FIG. 3, showing internal components of the processing module; and

FIG. 5 is a schematic circuit diagram of a processor board that may form part of a castor control unit in accordance with an embodiment of the present invention.

### DETAILED DESCRIPTION OF EMBODIMENTS OF THE INVENTION

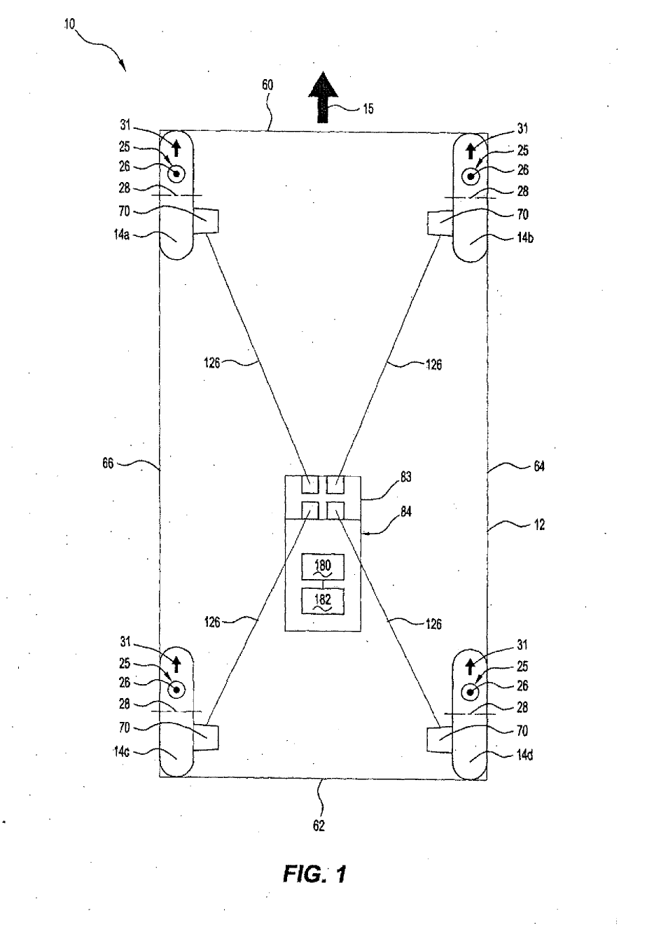

Various aspects of the present invention are described with reference to a castor-mounted ground or floor mobile item 10, represented conceptually in FIG. 1 in plan view. The castor-mounted item 10 may be for example a trolley or hospital bed. The castor-mounted item 10 has body in the form of a frame 12 having a generally rectangular perimeter in plan. The frame is generally rigid, but may have a fixed configuration or may be capable of articulation into different configurations. Four castor wheels 14(a-d) are fixed beneath each corner of the castor-mounted item 10 by a fixed and irrotational connection between the frame 12 and a pintle 25 upstanding from each castor 14. In another embodiment, the castor body may be a female component, e.g. bolted from above. The pintle 25 runs through a cavity (not shown) in the castor wheel 14 to enable the castor to swivel about a swivel axis 26, which is the pintle's longitudinal axis (perpendicular to the page on which FIG. 1 is illustrated).

The swivel axis is off-centre to the rolling axis 28 of is corresponding castor 14, so that during motion the pintle 25 leads the axis 28. Accordingly, each castor 14 has, at any given time, a specific orientation with respect to the swivel axis 26 when the castor-mounted item rolls in a given direction 15. For each castor, this direction is illustrated by a corresponding vector 31, but the direction can alternatively be referenced in other ways. By contrast, if the swivel axis 26 were to intersect with the rolling axis 28, then each castor 14 could potentially be in one of two parallel, but oppositely oriented, configurations.

Each castor is selectively configurable into one of three modes: (i) a free mode, in which the castor 14, can freely swivel about the swivel axis 26 and the wheels of the castor are free to roll about the rolling axis 28; (ii) a brake mode, in which the wheels are locked 20, against rolling about the rolling axis and, in one embodiment, the castor is also locked against swivelling about the swivel axis; and (iii) a direction lock mode, in which the castor 14 is locked against swivelling about the swivel axis 26, but the wheels are still free to roll about the rolling axis 28.

It is appreciated that the term “lock” or “locked” is preferably a positive lock in which all movement and swivel rotation is prevented. However, a lock may also be effected by imposing a limited range of angular movement, for example 15 degrees. A direction lock may, alternatively, be a “soft” lock such as may be implemented by friction, whereby the swivel is severely restricted but is not necessarily retained within specific angular boundaries.

An example of a castor wheel having these three modes of operation is described in international patent application publication WO 2008/148169, which is incorporated herein by reference and describes how each of the three modes may be implemented and selected.

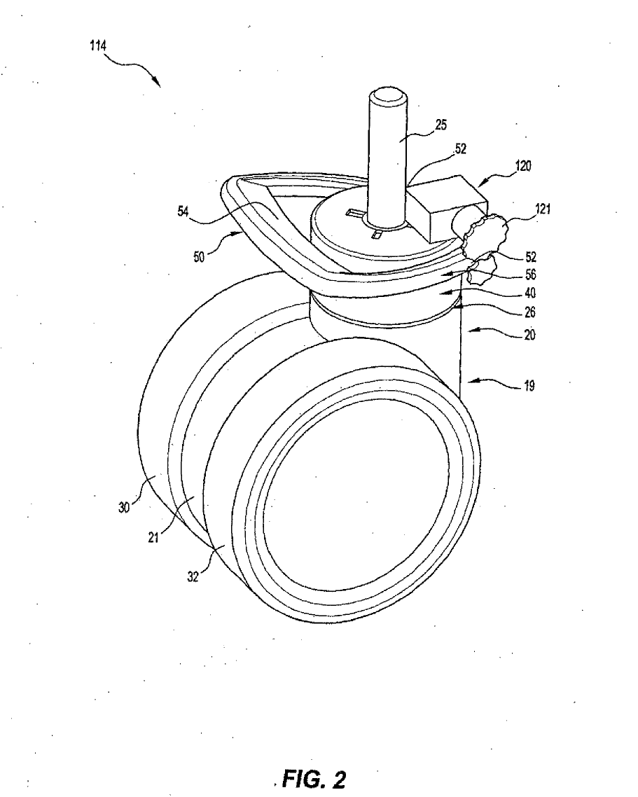

FIG. 2 illustrates a swivel castor 114 that is in accordance with the disclosure in WO 2008/148169, and is thus operable in each of the three modes. The castor 114 includes a main body 20 that journals a pair of rotatable wheels 30,32 engageable with a floor or ground surface below the body. Body 20 is in two principal parts: a bi-flanged disc portion 21 between the wheels that is truncated at its base to clear the underlying floor or ground surface, and a broader upstanding portion 19, of generally annular cross-section at its upper end, projecting eccentrically from the disc portion.

The castor 114 includes an activator 50 having a transverse foot-engageable web 54 by which it can be operated as a pedal. Rotating the actuator up or down about pivot axis 56 moves the activator into a position that causes internal components of the castor to engage into one of the three modes of operation, as described in WO 2008/148169.

While, in this embodiment, a single actuator selects all three modes of operation, it is appreciated that in other embodiments, the locking of the castor's swivel axis and the wheel rotation axis may be independently controlled. In such an embodiment, the direction-lock mode and free-mode permit the wheels to freely rotate about the rolling axis, but the castor's ability to actually roll is determined by an independent brake that overlies the castor, and may be applied regardless of whether the swivel axis is locked or free.

In the direction-lock mode, the castor direction 31 locks when the castor aligns with one of four positions that are spaced 90 degrees from each other about the swivel axis 26, such that the direction 31, when locked, is directed towards the front 60, rear 62, right side 64 or left side 66 of the castor-mounted item 10 to which it is fixed. In a preferred embodiment, instead of there being four positions, there two only positions, spaced 180 degrees apart. In this case, the castor may be locked when the direction 31 is towards the front 60 or rear 62. In another embodiment, for castor-mounted items only intended to be pushed from the rear 62 of the item, there only need be a single direction-lock position, for locking the castor when the direction 31 is towards the front 60.

As an alternative to foot (or manual) actuation of brake activator 50, means is provided to electronically control the brake activator 50 by electromechanically actuating the brake activator 50. This may be achieved while maintaining manual operability. In the example in FIG. 2, a servo device 120 is mounted atop cap 40 of upstanding body portion 19 and has a geared connection 121 to the axle cross-piece 52 that runs opposite the webbed portion 54 of the activator 50, marginally behind the pivot axis 56 of the activator 50.

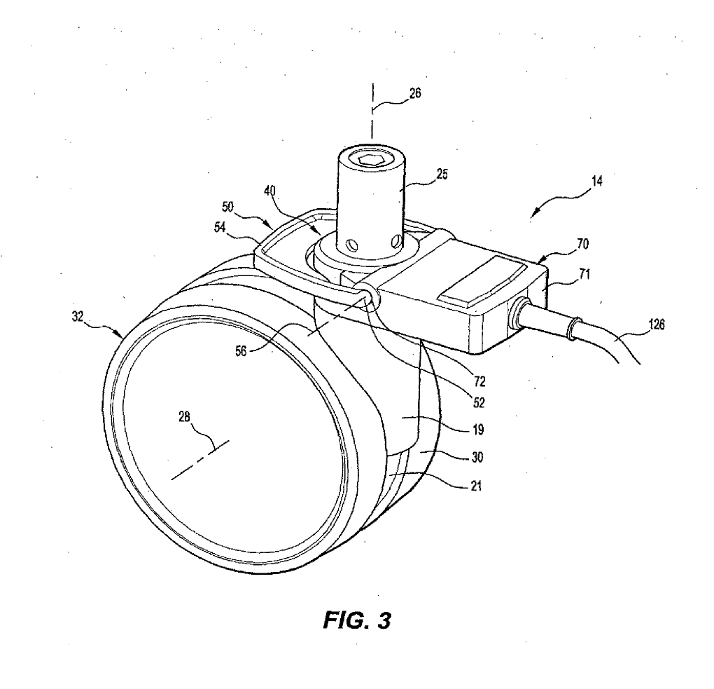

FIG. 3 illustrates a representative one of the swivel castors 14 of FIG. 1. This swivel castor 14 has the same mechanical operation as swivel castor 114, but includes a castor control unit 70 incorporated into the castor. The castor control unit has a generally rectangular housing 71 that encloses electronic, mechanical and electromechanical components for intelligently controlling the mode of the castor. Optionally, parts of the housing 71 may be integrally formed with cap 40 (FIG. 2) of the swivel castor. The housing 71 includes a pair of openings 72 through which cross piece 52 of the activator 50 passes.

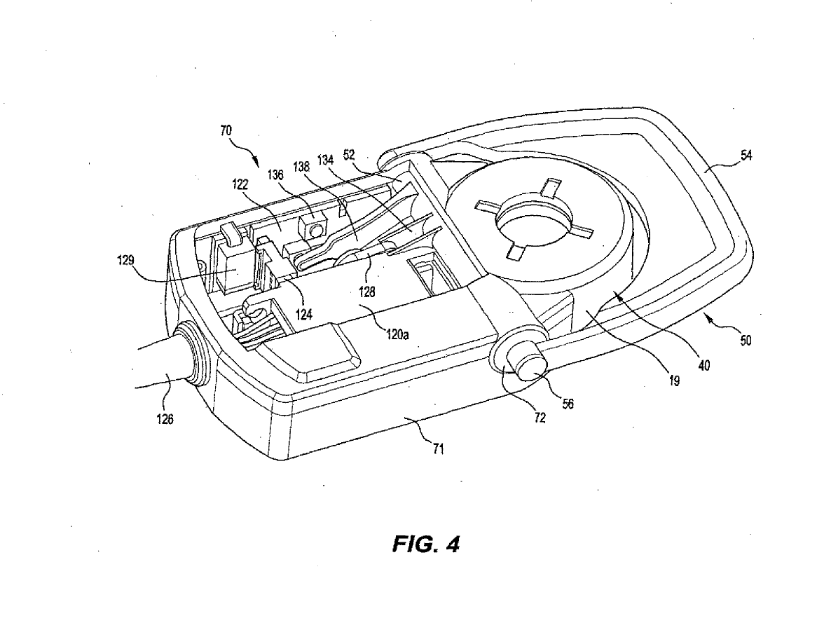

An enlarged view of the castor control unit of FIG. 3 is provided in FIG. 4, with a portion of housing 71 cut away to show components within the castor control unit 70. The castor control unit includes servo motor 120a that is driven by a signal or signals that are received on a processor board 122 that seats vertically along a side of the unit and carries a servo connector 129. The received signal is a control signal that is delivered to the processor board from a cable 126, via cable connector 124. The servo motor 120a has a drive shaft (not shown) about which a lever 128 is fixed by an end screw. A distal end of the lever 128 pivotally joins to a crank 134 that projects laterally from axle cross piece 52 of activator 50. Rotation of the motor drive shaft thus actuates rotation of the activator 50 into a position that configures the castor 14 into the mode commanded by the control signal.

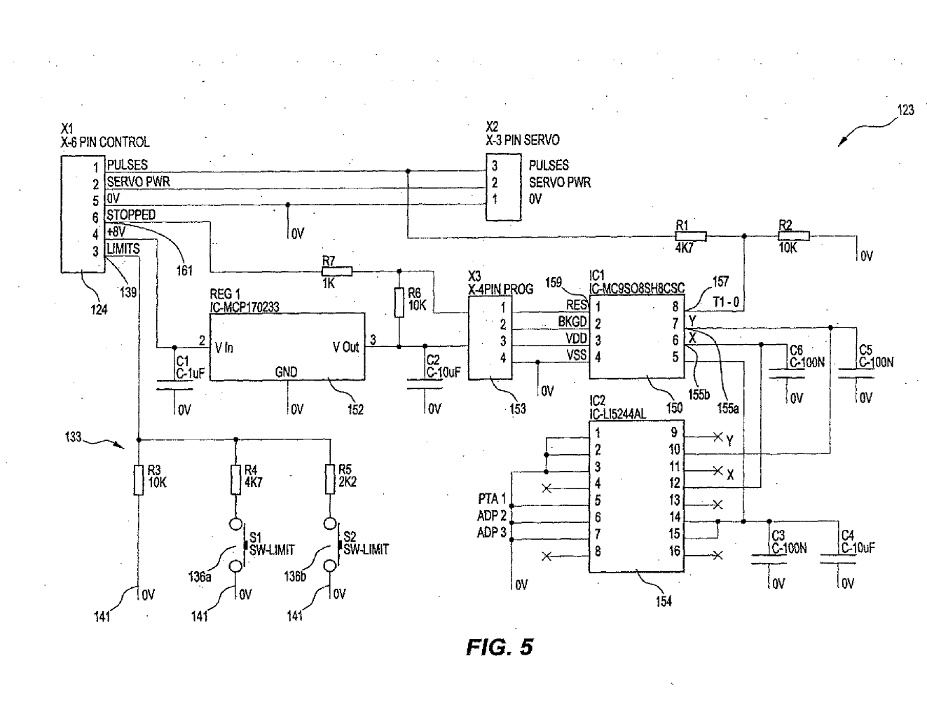

Processor board 122 includes electronic components for measurement, processing and control functions. A simplified schematic diagram of the processor board circuit 123 is depicted in FIG. 5.

The processor board 122 has a feedback circuit 133 which includes two or three (three are illustrated) switches 136. These switches are mechanically actuated by a projecting arm 138 on the axle cross piece 52 to provide electronic feedback of the actual position state of the activator 50, and hence the actual operating mode of the castor wheel. Switches 138 may alternatively be triggered by any suitable mechanism, e.g. optically. If two switches are provided (the arrangement illustrated in FIG. 5) there are three possible combinations (both switches 136 open, both switches 136 closed, only one of the switches open), used to designate the three castor states. Each combination results in the feedback circuit 133 having a different resistance between pin 139 of connector 124 and the electrical zero-volt reference 141. Measuring the different electrical resistance therefore allows determination of the castor state. Where there are three switches 136, as illustrated in FIG. 4, four combinations are possible (the respective switches on or none on).

Processor board 122 further includes a processing module, in the form of a microcontroller 150, powered from voltage regulator 152 that regulates voltage supplied to the board via connector 124. The microcontroller 150 is programmed via a 4-pin programming connector 153. The microcontroller includes an input comprised of two microcontroller input pins 155(a,b), for receiving a signal from accelerometer 154, such as part number LIS244AL, that measures motion in terms of acceleration and direction. The signal is comprised of two orthogonal axis components that are separately communicated from the accelerometer 154 to microcontroller 150 on the two pins 155a,155b, respectively. It is appreciated that in other embodiments, all components of the measured data could be digitally communicated over a single track to a single pin on the microcontroller and then decoded to determine the component data for each axis.

In other embodiments, the acceleration measurement may be a three-axis measurement, giving higher sensitivity and better baseline control.

From processing of the accelerometer data, velocity data may also be derived. The velocity is determined by integrating the measured acceleration, thus allowing the direction of travel to be determined, as well as the duration of travel in that direction.

The microcontroller 150 reads the measured motion signal from the accelerometer 154 to determine whether the motion satisfies at least one predefined condition. If the predefined condition is satisfied, it can be deduced that there is a need to engage or disengage the direction lock. Accordingly, in the event that the condition is satisfied, the microcontroller 150 characterises a need to engage or disengage the direction lock based on motion data, derived from the motion signal, and generates at least one output signal indicating the characterisation. The characterisation defines which of engagement or disengagement is needed and to which castors 14a-d the direction-lock should be applied. Optionally, the microcontroller may generate a control signal at an output 157 to selectively control engagement or disengagement of the direction lock in accordance with the characterised need.

In an embodiment, motion data from an accelerometer on just a selected one of the four castors may be used to determine a mode for each the four castors, and preferably the decision as to the mode in which each castor is to operate is made by a single processor. In this manner, the operation mode of each of the wheels is coordinated, giving the best steering control for the castor-mounted item.

In one embodiment the decision of the mode in which each castor is to operate is made by a control system that is separate from the microcontroller 150. The microcontroller 150 generates at least one output signal, at output 159, indicating the characterisation that has been determined. While multiple outputs signal could be used to indicate the determined characterisation, less cumbersomely the determined characterisation is encoded on a single signal which is transmitted from a pin 161 of connector 124 to a communications module 83 (FIG. 1) on central control system 84, via cable 126.

The control system 84 includes a processing system in the form of a processor 180 or a plurality of processors, and, generally, a separate memory system 182 that stores computer executable instructions that are read and executed by the processing system 180. Optionally, the control system may itself determine the characterisation from motion data, rather than receiving the characterisation from the castor control unit 70. The control system may therefore further include its own accelerometer (not shown) from which the motion data is derived.

The control system 84 receives the characterisation from the processing module 70 and determines, from at least one predefined criterion, if and how to engage or disengage the direction-lock. In other words, it determines the mode of operation for each of the castors 14. Once the determination is made, the control system generates a control signal for each of the castor control units 70 to control their respective servo-motors according to the determined mode of operation. The communications module 83 transmits the control signals to the respective castors 14 via the corresponding cables 126.

The predefined criterion or criteria take into account factors in addition to the characterisation by the castor control unit 70. In this manner, the need for engagement or disengagement of direction lock, as defined by the characterisation, may be overridden by the control system, based on other priorities. It is therefore appreciated that the characterisation of a “need” for engagement or disengagement of direction lock may not correlate to an absolute necessity, but rather is more aligned with a need as perceived in isolation of other factors. Taking the other factors into account, “a need” may, in fact, be a preference or recommendation.

The control system also includes a user interface display and input terminal (not shown), to allow customisation and interaction by an operator. This customisation, combined with the ability to control the predefined criteria, allows the operation of the item 10 as a whole to be optimised for its purpose at any given time.

The user interface may, for example, have a single button for complete manual castor control. The button may require a long press to deactivate autosteer functionality, and a second long press to reactivate, the system defaulting to autosteer ON whenever taken out of brake. This is for complicated maneuvering, or compatibility with bed movers and bed wash tunnels. Alternatively the system might default to autosteer OFF and is turned ON when the single button is toggled between three states: brake, free, autosteer.

In the case of the item 10 being a hospital bed, for example, the control system may be configured that in the event that (i) the bed is in a ward and (ii) the current time is during normal waking hours, say 8am to 10pm, the direction lock is never to be engaged, unless a user/operator explicitly instructs the engagement.

In another configuration, the control unit is configured such that the prescribed criterion is that a newly changed characteristic (eg a need to engage direction lock) remains constant for a pre-selected period, such as 30 seconds or 1 minute, before the control signal is generated in accordance with the new characteristic.

Various methods exemplifying predefined conditions for motion data and the resulting characterisation that occurs when such conditions are satisfied are now described.

### Example 1

In one configuration, the castor control unit 70 or control system 180 (depending on which is configured to determine the characterisation) characterises a need to engage the direction lock if the motion correlates to movement in a steady direction for a prescribed period, for example 3 seconds.

The characterisation also defines that the direction lock is required for the “front” castor wheels, ie the two castors 14a, 14b that lead other castors 14c, 14d, when the castor-mounted item is moving in direction 15.

The reason for locking the leading wheels is that, generally, items on castor wheels are pushed, rather than pulled, so the person doing the pushing is located on the side of the castor-mounted item 10 that is opposite the leading castors 14a, 14b. The person can most easily manoeuvre the item at the end of the item that they are pushing. Thus, the castors 14c, 14d nearest them are maintained in the free mode.

By detecting a need for (and applying) direction lock in response to a constant motion, it can be assured that the castor directions 31 are aligned with the direction of motion 15. By contrast, if the direction lock is applied in anticipation of such a motion, then the castors may lock in a position that is not aligned with the direction 15, for example in the opposite direction.

It is noted that in the above example, it is also possible to apply direction-lock to only one of the front castors, eg castor 14a, leaving all other castors in the free mode. This will still provide improved steering compared to all castors being in the free mode, but the pivot point about which steering is controlled would in this case be at the direction locked castor 14a. Therefore it is preferable to lock both front castors, as this results in the steering pivot point being midway between the two front castors 14a, 14b, which makes the castor-mounted item easier to steer.

### Example 2

In another scenario, the castor control unit 70 or control system 180 characterises a need to disengage the direction lock, when the motion data indicates that the motion has come to rest for a prescribed period, eg 1 second. Put another way, the characterisation defines a need to engage free mode of operation if this condition is met.

### Example 3

When a castor-mounted item, such as a trolley, is being pushed down a hallway and direction lock is engaged, there may be a need to suddenly change direction in a lateral direction. This need may arise if, for example, an obstruction suddenly appears in the present trajectory of the castor-mounted item.

To enable immediate lateral movement (as opposed to steering through a turn), the direction lock should be disengaged and the castors should revert to the free movement mode.

When a person, in response to the obstruction, suddenly forces a lateral change in direction, the motion data rapidly changes the measured direction and the magnitude of the motion in that direction. There may also be an accompanying rapid deceleration in the motion down the hallway. Consequently, the motion data may represent a vector that correlates with a large deceleration in a first direction and an increase in acceleration in a second direction. The motion data may thus be composed of two subsets of motion data, corresponding respectively to two directional axes. Generally, the other examples described herein will also involve data for two axes.

When the respective acceleration and/or deceleration values exceed a predefined threshold, the processing module or control module characterises a need to disengage direction lock from all castors, so that each castor is in free mode.

In this case the prescribed period for determining the need to disengage the direction lock (or engage free mode) is preferably less than one second.

Generally, the prescribed period for characterising a need to disengage the direction lock is shorter than characterising a need to engage direction lock. This is because when there is a sudden change of direction, the castor wheels need to be able to quickly respond to the change in direction by reverting to free mode of operation.

### Other Variations

It is appreciated that the direction-lock(s) need not be incorporated onto the castors themselves. Means may be incorporated into the frame of the castor-mounted item for example to implement the direction lock. In one arrangement a downward pressure may be applied onto the castors to exert a friction force against a part of the castor body, prevent swivelling by an action of friction against the body, but allowing the wheels to still freely roll.

It is also appreciated that the various processing systems in accordance with the invention may be implemented without a dedicated memory for storing instructions and configuring the processing system. Some processing systems, especially microcontrollers, may include integrated memory. In other processing systems, instructions may be hard coded into the processing chip, such as in the case of an Application-Specific Integrated Circuit (ASIC) chip. However, it will often be advantageous to include a dedicated memory from which instructions may be read.

1. A castor control unit for a swivel castor having a plurality of selectable modes of operation, the modes of operation including at least: (i) a free mode, in which the castor can freely swivel about a swivel axis and a wheel or wheels of the castor can rotate about a rolling axis; (ii) a direction lock mode, in which the castor is locked against swivelling about the swivel axis and the wheel or wheels of the castor can rotate about a rolling axis, wherein the castor control unit comprises:
a measuring means for measuring motion in terms of acceleration and direction;
a processing means that deduces, from the measured motion, whether there is a need to engage or disengage the direction lock mode; and
an actuating means for actuating the castor to engage or disengage the direction-lock mode of operation, the actuating means being controllable by a control signal,
wherein the control signal is determined, at least in part, from said deduction of whether there is a need to engage or disengage the direction lock mode.

2. (canceled)

3. (canceled)

4. A castor control unit according to claim 1, wherein the measuring means is an accelerometer that measures motion on two or three axes.

5. A castor control unit according to claim 1, wherein the actuating means includes an electromechanical device for actuating an activator on a swivel castor, the activator having a plurality of selectable positions that engage respective selectable modes of operation of the swivel castor.

6. A castor control unit according to claim 5, wherein the electromechanical device is a servo or stepper motor.

7. A castor control unit according to claim 1, further including an arrangement for determining the mode of operation in which the swivel castor is operating.

8. (canceled)

9. (canceled)

10. A castor control unit according to claim 1, wherein the castor is configured such that the direction lock mode locks the castor against swivelling from a predefined direction of orientation.

11. A swivel castor having a direction-lock mode and a free mode, the castor including an activator for selectively engaging and disengaging the direction-lock mode and a castor control unit according to claim 1, wherein the actuating means of the castor control unit actuates the activator to engage or disengage the direction-lock mode.

12. A ground or floor mobile item having a body end a plurality of swivel castors on which the body is mounted, at least one of the swivel castors being a swivel castor In accordance with claim 11.

13. A ground or floor mobile item according to claim 12, wherein each of the other swivel castors on which the item is mounted comprises at least:
a means for mounting the swivel castor to an item;
at least one wheel attached to the mounting means such that it has (i) a horizontal rolling axis for rolling along a ground surface when the item is mounted on the castor, and (ii) a vertical swivel axis about which the swivel castor may swivel;
a plurality of selectable modes of operation, the modes of operation Including at least: (i) a free mode, in which the castor can freely swivel about a swivel axis; (ii) a direction lock mode, in which the castor is locked against swivelling about the swivel axis; and
an electronically controllable activator having a plurality of selectable positions that engage the respective selectable modes of operation of the swivel castor.

14. A processing module for a castor-mounted item having a plurality of swivel castors on which the item may stand, wherein the castors are rotatable to swivel about a generally upright axis with respect to the Item when the item stands on the castors, wherein the item includes a direction-lock that is selectable to lock one or more of the castors against said swivel rotation while permitting a wheel or wheels of the castor to rotate about a rolling axis, the processing module including a processing system configured to:
receive a measurement signal measuring motion of the item or of at least one of the castors In terms of acceleration and direction: and
in the event that the measured motion satisfies at least one predefined condition: (i) characterise a need to engage or disengage the direction lock based on the measured motion and (ii) generate at least one output signal indicating said characterisation.

15. A processing module according to claim 14, wherein the predefined condition is
that the item or the at least one castor has motion in a constant direction for a prescribed period, and the characterisation includes a need to engage the direction lock.

16. A processing module according to claim 14, wherein the characterisation identifies (a) which of engagement or disengagement is needed, and (b) a subset of the castors for which the engagement or disengagement needs to be applied.

17. (canceled)

18. (canceled)

19. A processing module according to claim 14, wherein the characterisation is based on the quantitative, or scalar, measurement of the motion and a directional measurement of the motion that are made by the measurement signal.

20. A processing module according to claim 14, wherein the at least one output signal is a control signal for selectively controlling engagement or disengagement of the direction lock in accordance with the characterised need.

21. A processing module according to claim 14, further including a memory system for storing computer program processing instructions, the memory system being readable by the processing system to execute said instructions, wherein execution of the instructions by the processing system results in said configuration of the processing system.

22. (canceled)

23. A control system for a castor-mounted item having a plurality of swivel castors on which the item may stand, wherein the castors are rotatable to swivel about a generally upright axis with respect to the item when the item stands on the castors, wherein the item includes a direction-lock that is selectable to lock one or more of the castors against said rotation while permitting a wheel or wheels of the castor to rotate about a rolling axis, wherein the control system includes a processing system configured to:
select a mode of operation based on (i) characterisation of a need to engage or disengage the direction lock and (ii) additional factors; and
output at least one control signal in accordance with the selected mode to selectively control engagement or disengagement of the direction lock.
wherein the characterisation is derived based on motion data, the motion data encoding a measurement of motion of this item or at least one of the castor wheels in terms of acceleration and direction.

24. A control system according to claim 23, further including an input for receiving at least one input signal that indicates the characterisation.

25. A control system according to claim 23, further including an accelerometer that measures motion on two or three axis and from which the motion data is generated.

26. A control system according to claim 23, wherein the control system is further configured such that in the event that the motion data satisfies at least one predefined condition, the processing system characterises the need for engagement or disengagement of the direction lock.

27. A control system according to claim 23, further including a memory system for storing computer program processing instructions, the memory system being readable by the processing system to execute said instructions, wherein execution of the instructions by the processing system results in said configuration of the processing system.

28. (canceled)
